(19) United States
(12) Patent Application Publication
(10) Pub. No.: US 2023/0043527 A1
(43) Pub. Date: Feb. 9, 2023

(54) SUBASSEMBLY INCLUDING A WHEEL HUB AND A CONSTANT VELOCITY JOINT

(71) Applicant: AKTIEBOLAGET SKF, Goteborg (SE)

(72) Inventors: Tom SCHMITZ, Hambach (DE); Klaus Dietmar RIPPSTEIN, Ebelsbach (DE); Lisa BAIERL, Schweinfurt (DE)

(21) Appl. No.: 17/866,791

(22) Filed: Jul. 18, 2022

(30) Foreign Application Priority Data
Aug. 5, 2021 (DE) 102021208491.5

(51) Int. Cl. B60B 27/00

(52) U.S. Cl. CPC B60B 27/0042; B60B 27/0078; B60B 27/0094; B60B 2310/314; B60B 2310/316; B60B 2380/73

(57) ABSTRACT

A subassembly includes a wheel hub and a constant velocity joint. The constant velocity joint includes a bell and the wheel hub is connected to the bell by high-pressure internal forming. Preferably, the wheel hub includes an axial projection disposed radially inside a connecting section of the bell, the projection interacting with the connecting section during the high-pressure internal forming process in order to connect the wheel hub to the bell. The projection is preferably configured to deform plastically and is connected to the bell in an interference-fit manner. Further, the wheel hub preferably provides an inner ring of a bearing unit and either the bell of the constant velocity joint provides another inner ring or a separate inner ring is disposed between the wheel hub and the bell.

### CROSS-REFERENCE

This application claims priority to German patent application no. 102021208491.5 filed on Aug. 5, 2021, the entire contents of which are fully incorporated herein by reference.

### BACKGROUND OF THE INVENTION

The present invention relates to vehicle axle assemblies, and more particularly to assemblies including a wheel hub and a constant velocity joint.

Known constant velocity joints for wheel hubs are typically non-rotatably connected to a knuckle of the wheel hub. Various types of connection may be used to connect the joint to the knuckle, such as for example, radial and/or axial gearings or toothed-shaft (i.e., “splined”) connections, which are typically secured by means of threaded fasteners such as nuts.

However, with such known types of connection, the toothed-shaft/splined connections on the one hand and the securing nuts on the other hand occupy a certain amount of space, so that potential space savings for the wheel hub and constant velocity joint assembly are limited by the presence of the toothed-shaft connections and the securing nut. In addition, the toothed-shaft connections and securing nuts are components whose required assembly involves time and cost. Furthermore, each additional element that is installed contributes to the total weight of the subassembly.

### SUMMARY OF THE INVENTION

It is therefore the object of the present invention to provide a subassembly made of a wheel hub and a constant velocity joint that is lighter weight, smaller and easier and less costly to manufacture.

This object is achieved by a proposed assembly which includes a wheel hub and a constant velocity joint having a bell. In order to both reduce the manufacturing costs and to design the subassembly to be more space-saving and lighter, the wheel hub is connected to the bell by high-pressure internal forming. The wheel hub and/or the bell are preferably hollow, so that the entire assembly has less weight.

The terms “high-pressure internal forming” or an “internal high-pressure deforming” is understood to mean herein a process in which a deforming of metallic hollow bodies is generated by internal pressure in a closed shaping tool, wherein the workpiece itself forms, to the greatest possible extent, the sealing envelope of the pressure. Due to the high-pressure internal forming, the use of toothed-shaft (i.e., splined) connections and securing nuts to connect the wheel hub to the constant velocity joint may be omitted, such that manufacturing costs, in particular the work complexity involved with manufacturing, can be reduced. Furthermore, the number of required components can be reduced since additional gearings, axle stubs, securing nuts, and the like can be omitted. Furthermore, a seal assembly can be provided for the sealing of the constant velocity joint or for the spacing of the constant velocity joint with respect to the interior of the wheel hub. In particular, the seal assembly can be configured as a metal and/or plastic cap.

According to a further preferred embodiment, the wheel hub includes an axial projection on a side facing the bell that is disposed radially inside the bell, wherein in order to connect the wheel hub to the bell, the projection is configured to interact during high-pressure internal forming with a connecting section formed on the bell. The projection is preferably configured to deform plastically. Furthermore, the bell of the constant velocity joint is configured to deform only elastically during high-pressure internal forming. This makes possible a secure and stable connection between the wheel hub and the bell. Since the bell deforms only elastically, during the internal high-pressure deforming it can represent a “counter-bearing” into which material deforms. That is, the bell can form an outer part into which an inner part, namely the wheel hub, is formed during internal high-pressure deforming.

After the high-pressure internal forming, the projection is preferably connected to the bell in an interference-fit manner. For example, an edge of the projection that protrudes over the connecting section can be additionally processed by flanging, tumbling, and/or orbital shaping in order to increase the interference fit. Furthermore, after the high-pressure internal forming, an undercut can be formed on the bell and/or the wheel hub. The projection and/or the connecting section of the bell is preferably configured or formed generally wedge-shaped. In particular, a wider or thicker side of the wedge can be disposed on the side of the component that points to or extends toward the other component. For example, when the projection of the wheel hub is formed wedge-shaped, the end of the projection that is proximal to the constant velocity joint (i.e., the projection outer end) may be formed with an increased thickness, in other words, the section of the projection adjacent to the wheel hub has a lesser or reduced thickness in comparison with the projection outer end. The connection between the wheel hub and the bell of the constant velocity joint can be further secured thereby.

Furthermore, the bell and/or the wheel hub may include at least one locking element, wherein the at least one locking element is preferably provided on the projection and/or the connecting section. The one or more locking element(s) may have, for example, gearing structures, corresponding concave and convex elements, a wave shape, etc., that are configured in particular to ensure the interference fit by interconnecting or interlocking during joining of the wheel hub and the bell.

According to a further preferred embodiment, the subassembly further includes a rolling-element bearing unit including at least two rows of rolling elements, wherein the wheel hub is configured as an inner ring for the rolling-element bearing unit and includes at least one first inner raceway for one row of the rolling elements and the bell is configured as an inner ring for the rolling-element bearing unit and includes a second inner raceway for a second row of the rolling elements. This makes possible a reduction of the number of components of the subassembly.

Furthermore, the subassembly may include an inner ring element that is connected to the wheel hub in a friction-fit manner. Alternatively, the subassembly can include an inner ring element that is connected to the bell, wherein the inner ring element is disposed between the wheel hub and the bell. The inner ring element is preferably formed separately and axially clamped between the wheel hub and the bell. The end position of the inner ring element can thereby be advantageously fixed. Due to the separate formation of the inner ring element, the second inner raceway can in particular be manufactured more easily. The inner ring element can also be manufactured from a different material than the bell.

According to a further aspect, a method is proposed for the manufacturing of the subassembly mentioned above, wherein the method includes connecting the wheel hub to the bell by high-pressure internal forming.

Further advantages and advantageous embodiments are specified in the description, the drawings, and the claims. Here in particular the combinations of features specified in the description and in the drawings are purely exemplary, so that the features can also be present individually or combined in other ways.

### BRIEF DESCRIPTION OF THE SEVERAL VIEWS OF THE DRAWING

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

FIG. 1 shows a subassembly according to a first embodiment;

FIG. 2 shows a subassembly according to a second embodiment;

FIGS. 3A-C show representations of a detail X of the subassembly of FIG. 1;

FIG. 4 shows the first embodiment subassembly of FIG. 1 incorporated with a bearing unit; and

FIG. 5 shows the second embodiment subassembly of FIG. 2 incorporated with a bearing unit.

### DETAILED DESCRIPTION OF THE INVENTION

In the following, identical or functionally equivalent elements are designated by the same reference numbers.

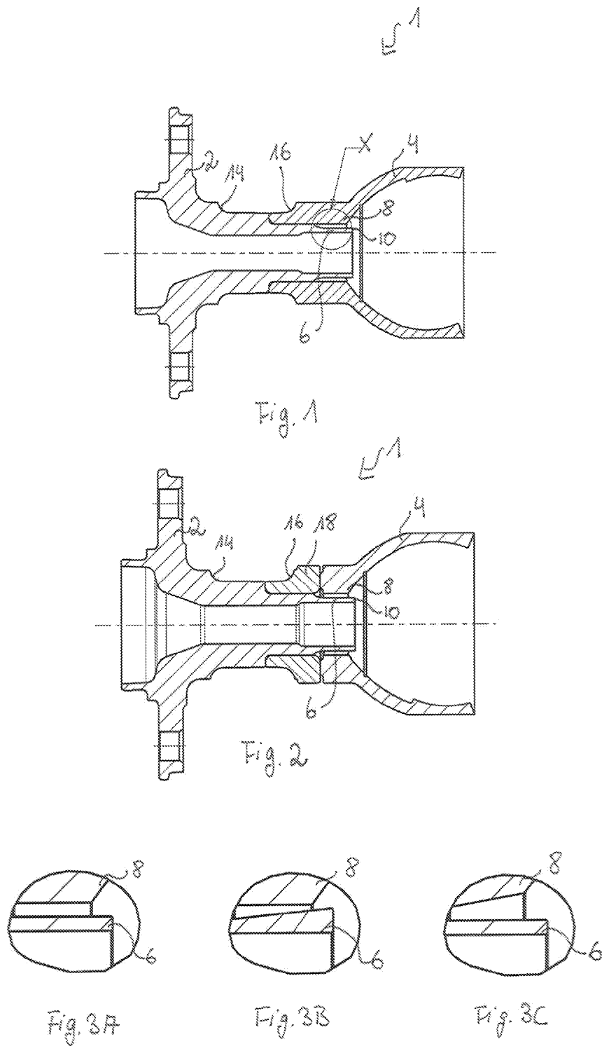

FIGS. 1, 2, 4 and 5 each show a subassembly 1 including a wheel hub 2 and a constant velocity joint (only partially shown) that includes a bell 4. The wheel hub 2 has an axial projection 6 on a side facing the bell 4 that is disposed radially inside the bell 4. The wheel hub and the bell are preferably hollow so that the entire assembly is lighter.

The subassembly 1 further comprises a rolling-element bearing unit 11 including at least two rows of rolling elements 12, wherein the wheel hub 2 is configured as inner ring for the rolling-element bearing unit 11 and includes at least one first inner raceway 14 for a first row of the rolling elements 12. In the exemplary embodiment depicted in FIGS. 1 and 4, the bell 4 is also configured as inner ring for the rolling-element bearing unit 11 and provides a second inner raceway 16 for a second row of the rolling elements 12.

In contrast, in the exemplary embodiment shown in FIGS. 2 and 5, a separate inner ring element 18 is provided that is disposed and axially clamped between the wheel hub 2 and the bell 4. In such a construction, the second inner raceway 16 is formed on the separate inner ring element 18.

In the exemplary embodiments shown in FIGS. 1, 2, 4 and 5, the wheel hub 2 is connected to the bell 4 by high-pressure internal forming, wherein the projection 6 is configured to interact during high-pressure internal forming with a connecting section 8 formed on the bell 4 in order to connect the wheel hub 2 to the bell 4. In this case, the projection 6 can be configured to deform plastically, whereas the bell 4 of the constant velocity joint is configured to deform only elastically during high-pressure internal forming, and to form a counter-bearing for the high-pressure internal forming.

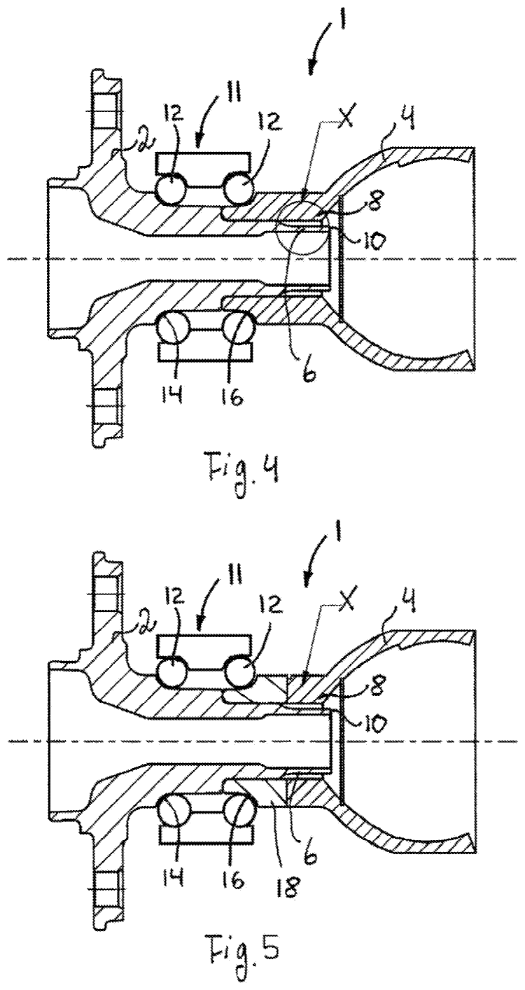

FIGS. 3A, 3B, and 3C show in detail a section X from FIG. 1. FIG. 3A shows an example wherein the projection 6 and the connecting section 8 are each configured or formed generally straight. However, in order to achieve an improved locking between the wheel hub 2 and the bell 4, the projection 6 may alternatively be formed wedge-shaped, as is shown in FIG. 3B, or the connecting section 8 of the bell 4 may be formed wedge-shaped, as is shown in FIG. 3C. After the high-pressure internal forming, the projection 6 is thereby connected to the bell in an interference-fit manner. In addition, an edge 10 of the projection 6 can be processed by flanging, tumbling, and/or orbital shaping in order to increase the interference fit. Furthermore, after the high-pressure internal forming, an undercut may be formed on the bell 4 and/or the wheel hub 2.

In summary, a subassembly 1 is provided that includes a wheel hub 2 and a bell 4 of a constant velocity joint, wherein the wheel hub 2 and the bell 4 are connected to each other via high-pressure internal forming. As such, components such as gearings or toothed-shaft connections (e.g., splined shafts) and securing nuts, which are typically used to connect a wheel hub and a bell can thereby be eliminated. The elimination of such components reduces the weight of the subassembly and the installation space previously occupied by the toothed-shaft connections and securing nuts. Additionally, the bell and/or the wheel hub can be configured or formed hollow, which leads to additional weight reduction.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMBER LIST

1 Assembly

2 Wheel hub

4 Bell

6 Projection

8 Connecting section

10 Edge

11 Bearing unit

12 Rolling elements

14, 16 Inner raceway

18 Inner ring element

We claim:

1. A subassembly comprising:
a wheel hub; and
a constant velocity joint including a bell, the wheel hub being connected to the bell by high-pressure internal forming.

2. The subassembly according to claim 1, wherein on a side facing the bell, the wheel hub includes an axial projection disposed radially inside the bell, the projection being configured to interact during high-pressure internal forming with a connecting section formed on the bell so as to connect the wheel hub to the bell.

3. The subassembly according to claim 2, wherein the projection is configured to deform plastically.

4. The subassembly according to claim 2, wherein after the high-pressure internal forming, the projection is connected to the bell by an interference fit.

5. The subassembly according to claim 1, wherein after the high-pressure internal forming, an undercut is formed on the bell and/or the wheel hub.

6. The subassembly according to claim 2, wherein the bell and/or the wheel hub includes at least one locking element, wherein the at least one locking element is provided on the projection and/or the connecting section.

7. The subassembly according to claim 2, wherein the projection and/or the connecting section of the bell is formed so as to be wedge-shaped.

8. The subassembly according to claim 1, wherein:
the subassembly includes a rolling-element bearing unit including at least two rows of rolling elements;
the wheel hub is configured as an inner ring for the rolling-element bearing unit and includes at least one first inner raceway for one row of the rolling elements; and
the bell is configured as inner ring for the rolling-element bearing unit and includes a second inner raceway for a second row of the rolling elements.

9. The subassembly according to claim 1, further comprising a bearing inner ring element connected to the wheel hub by a friction-fit.

10. The subassembly according to claim 9, wherein the bearing inner ring element is connected to the bell and disposed between the wheel hub and the bell.

11. The subassembly according to claim 10, wherein the bearing inner ring element is formed separately of, and axially clamped between, the wheel hub and the bell.

12. The subassembly according to claim 1, wherein the wheel hub and/or the bell are hollow.

13. A method of manufacturing a subassembly including the steps of:
providing a wheel hub and a bell; and
connecting of the wheel hub to the bell by high-pressure internal forming.

14. The method according to claim 13, wherein:
the step of providing a wheel hub and a bell includes providing a wheel hub with an axial projection and providing a bell with a connecting section;
the method further comprises the step of disposing the axial projection radially within the connecting section of the bell, the projection being configured to interact during high-pressure internal forming with the connecting section formed on the bell in order to connect the wheel hub to the bell.
